(19) United States
(12) Patent Application Publication
(10) Pub. No.: US 2009/0305660 A1
(43) Pub. Date: Dec. 10, 2009

(54) SYSTEM FOR CONVEYING AND ANNOUNCING EMERGENCY BROADCAST MESSAGE WITH RADIO

(76) Inventor: Feng-Yu Liu, Hsin Chuang City (TW)

Correspondence Address: LEONG C LEI, PMB # 1008, 1867 YGNACIO VALLEY ROAD, WALNUT CREEK, CA, 94598, US

(21) Appl. No.: 12/512,037

(22) Filed: Jul. 30, 2009

(30) Foreign Application Priority Data
Jan. 8, 2008 (TW) 097129478

(51) Int. Cl. H04M 11/04

(52) U.S. Cl. 455/404.1; 340/286.02

(57) ABSTRACT

Disclosed is a system for conveying and announcing an emergency message with radios, which provides a broadcast system to be set up in a building, a community, or a public place such as an organization or a school. An emergency receiving device combines at least one radio receiver unit to receive an emergency event message transmitted from a public channel or an on-site channel in radio frequency and incorporates a speech amplifier to amplify and broadcast a voice signal to announce the emergency message to people within the area.

### (a) TECHNICAL FIELD OF THE INVENTION

The present invention generally relates to a system for conveying and announcing emergency messages with radios, and more particularly to a public broadcast system for emergency events, wherein the system comprises a plurality of emergency receiving devices distributed in a building or a scope of a given area to timely receive an announcement message of emergency condition from an event site, a management center, a weather bureau, or a police system for immediate broadcast to the public.

### (b) DESCRIPTION OF THE PRIOR ART

A conventional broadcasting device set up in a public place, such as a building, a community, a shopping mall, and a school is connected, in a wired manner, to a broadcast system of a management center to broadcast a message transmitted from the broadcast system of the management center or a message that is transmitted through connection between the broadcast system and other broadcast stations. Such a known system has several drawbacks. (1) The connection is established in a wired manner so that the installation of the system must be done in a time and labor consuming manner, and may not even be allowed at locations where wire laying may damage the structure or appearance of a building or where no electrical power is available. (2) Message transmittings may fail due to power failure or damage of wiring. (3) Only messages transmitted from a broadcast system of a remote control center (broadcast station) can be broadcasted. Therefore, the public cannot be immediately notified about an emergency event occurring nearby through the conventional broadcast system, causing immediate alarm being delayed. For example, in occurence of a building fire, the residents of the building may only have the knowledge of the occurrence of the fire, but they might not be aware of the information regarding to the location of fire, danger level, and evacuation measures for all building floors. This might cause chaos or even increase the potential risk. Thus, further improvement is needed for the known public broadcast system.

### SUMMARY OF THE INVENTION

In view of the above drawbacks of the known public broadcast system, the present invention aims to provide a system for conveying and announcing emergency messages with radios.

An objective of the present invention is to provide a system for transmitting and announcing emergency message with radio, which sets up a plurality of emergency receiving devices in a wireless manner at various locations in building or in a given area so as to simplify the installation with reduced costs.

Another objective of the present invention is to provide a system for transmitting and announcing emergency message with radio, comprising an emergency receiving device that has a radio receiver unit is set in a public channel and/or an on-site channel to receive a signal from any one of the following voice transmitting devices: voice transmitters, two-way radios, handsets or in-car radio devices of police systems.

A further objective of the present invention is to provide a system for transmitting and announcing emergency message with radio, comprising an emergency receiving device set in a public channel that is police dedicated channel and/or a NOAA (National Oceanic and Atmospheric Administration) dedicated channel to timely receive and broadcast an emergency event or the latest weather messages.

Yet a further objective of the present invention is to provide a system for transmitting and announcing emergency message with radio, comprising voice transmitting device may select one of a plurality emergency receiving devices, or a sub-group or all of the emergency receiving devices to receive and broadcast an emergency message provided thereby.

To achieve the above objectives, the present invention provides a system for transmitting and announcing emergency message with radio, which comprises a plurality of emergency receiving devices distributed in a building or a given area and at least one voice transmitting device.

The emergency receiving device comprises at least one radio receiver unit and a speech amplifier. When the emergency receiving device receives a voice message transmitted from the voice transmitting device, the voice message is filtered and amplified by the speech amplifier and then broadcast by a speaker connected to the speech amplifier to be heard by the public.

The voice transmitting device comprises at least one radio transmitter unit, which is a radio frequency (RF) transmitter that transmits a voice message in radio frequency to the emergency receiving devices.

The emergency receiving device sets in the radio receiver unit an address code, which may selectively contain at least a common address code or a combination of a dedicated address code and at least one common address code, wherein a receiving channel that is one or more public RF channels, or further including an on-site RF channel is set. Further, the public channels may include emergency broadcast public channels of police system or NOAA. Further, the emergency receiving device may comprise an emergency lighting unit, which comprises at least a storage battery and a light, which supplies electrical power for emergency lighting and broadcasting of an emergency message when external power supply fails or an emergency message is received.

The voice transmitting device can be a regular voice transmitter, a two-way radio, or a handset or in-car radio device of a police system. The voice transmitting device may be connected to an on-site control center (such as a communication service center or a security management center) in a wired manner for operation, and may further be connected, via the on-site control center, to other control centers through a network so as to expand the range and effectiveness of operation thereof.

In the operation of the above discussed broadcast system, the voice transmitting device can be used to select and enter a transmission address code, which can be a unique address code, a group address code, or the address codes of all the associated emergency receiving devices for transmission of an emergency message in the form of a voice radio message through the radio broadcast system. After the emergency receiving device receives the voice signal, the signal is amplified by the speech amplifier and then broadcast by a speaker connected thereto to be heard by the public, so that maneuverable and immediate broadcast of an emergency message can be realized. Further, the present invention may use the public channel to broadcast an emergency alarm message transmitted from a police system or NOAA.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block circuit diagram of a broadcast and voice transmitting device in accordance with the present invention.

FIG. 2 is a schematic perspective view of the broadcast and voice transmitting device of the present invention.

FIG. 3 is a schematic view demonstrating an application of the present invention.

FIG. 4 is a block circuit diagram of a broadcast and voice transmitting device in accordance with another embodiment of the present invention.

FIG. 5 is a block circuit diagram of a broadcast and voice transmitting device in accordance with yet another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

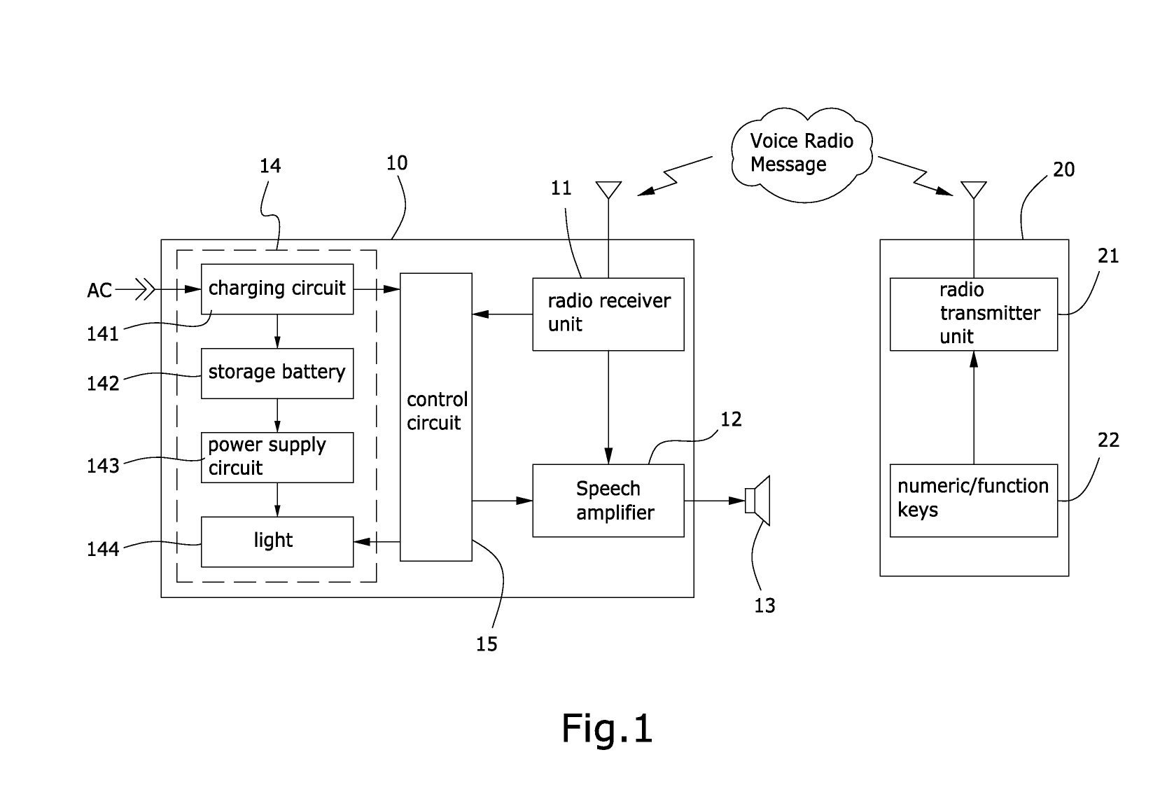

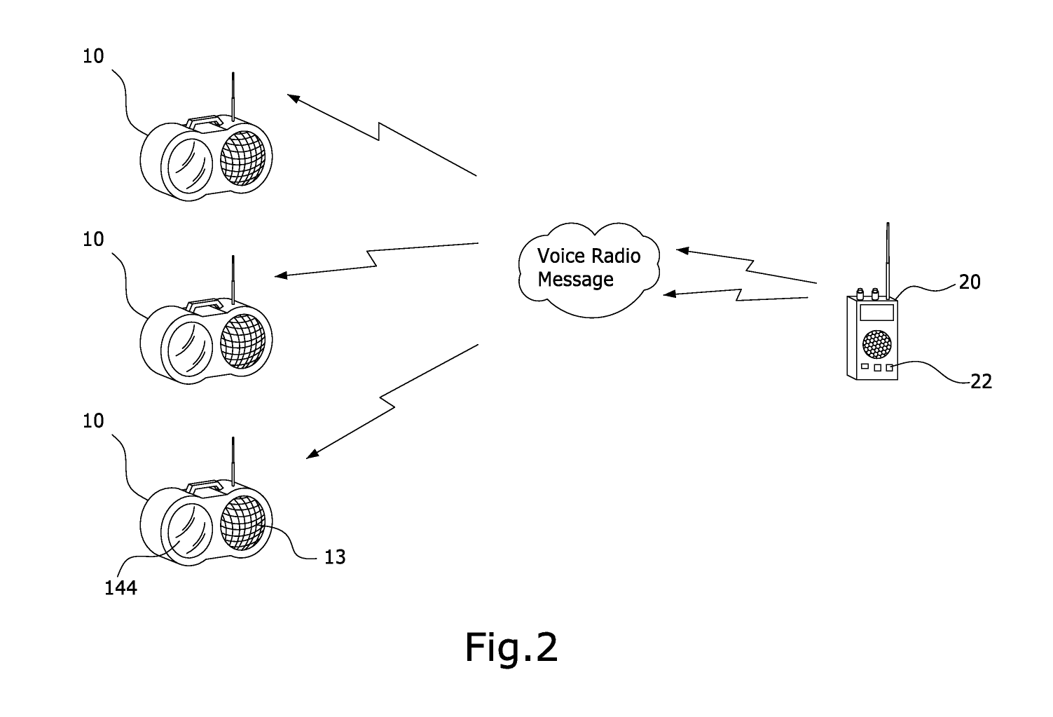

Referring to FIGS. 1 and 2, a system for conveying and announcing emergency broadcast message with radio in accordance with the present invention comprises a plurality of emergency receiving devices 10 distributed in for example a building or a given area and at least one voice transmitting device 20.

The emergency receiving device 10 comprises at least one radio receiver unit 11 and a speech amplifier 12. Each radio receiver unit 11, which comprises a receiver, a memory, and a processor, sets up at least an address code and a radio channel. When the radio receiver unit 11 receives a voice message transmitted from the voice transmitting device 20, the voice message is filtered and amplified by the speech amplifier 12 and then broadcast by a speaker 13 connected to the speech amplifier 12 in a voice form to be heard by the public.

The voice transmitting device 20 comprises at least one radio transmitter unit 21, which is a radio frequency (RF) transmitter that transmits a voice message in the form of voice radio signal to be received by the emergency receiving devices 10.

In the emergency receiving device 10, the address code set up in the radio receiver unit 11 may selectively contain at least a common address code or a combination of a dedicated address code and at least one common address code for identifying an address code contained in a radio signal. If the address codes match, then the emergency receiving device 10 is allowed to receive and broadcast a message so that the voice transmitting device 20 may select and control the range of broadcast based on needs.

Based on the desired function in operation and the position, the radio receiver unit 11 may set a receiving channel thereof to be one or more public RF channels, or selectively including an on-site RF channel (which is a user-selected dedicated/private communication channel specific to a local area or a given group so that similar function of limiting message receiving parties based on dedicated address codes thereof can also be achieved). The public channels may include emergency broadcast public channels of police system or NOAA for broadcasting emergency messages associated with the public or weather reports or other local emergency messages.

Further, the radio receiver unit 11 and the speech amplifier 12 included in the emergency receiving device 10 of the instant embodiment can be connected and used with an emergency lighting unit 14 and a control circuit 15. (The control circuit can be integrated with the radio receiver unit as a unitary device.) The emergency lighting unit 14 comprises a charging circuit 141, a storage battery 142, a power supply circuit 143, and a light 144. The charging circuit 141 of the emergency lighting unit 14 is connected to an alternating current (AC) power source to charge the storage battery 142 and is further connected to the power supply circuit 143 to supply electrical power to the components of the device. In operation, the control circuit 15 detects if the AC power source that supplies to the charging circuit 141 is in a cut-off condition and/or decides if the signal received by the radio receiver unit 11 is an emergency message to be announced. If the answers are positive, then the control circuit 15 generates a control signal so as to automatically activate emergency lighting and supply electrical power for lighting and broadcasting in case that the AC power source is cut off or an emergency message is received. Also, when the control circuit 15 determines that the signal received by the radio receiver unit 11 is an emergency message, interrupting announcing or broadcasting is performed to enhance the effectiveness of emergency broadcasting.

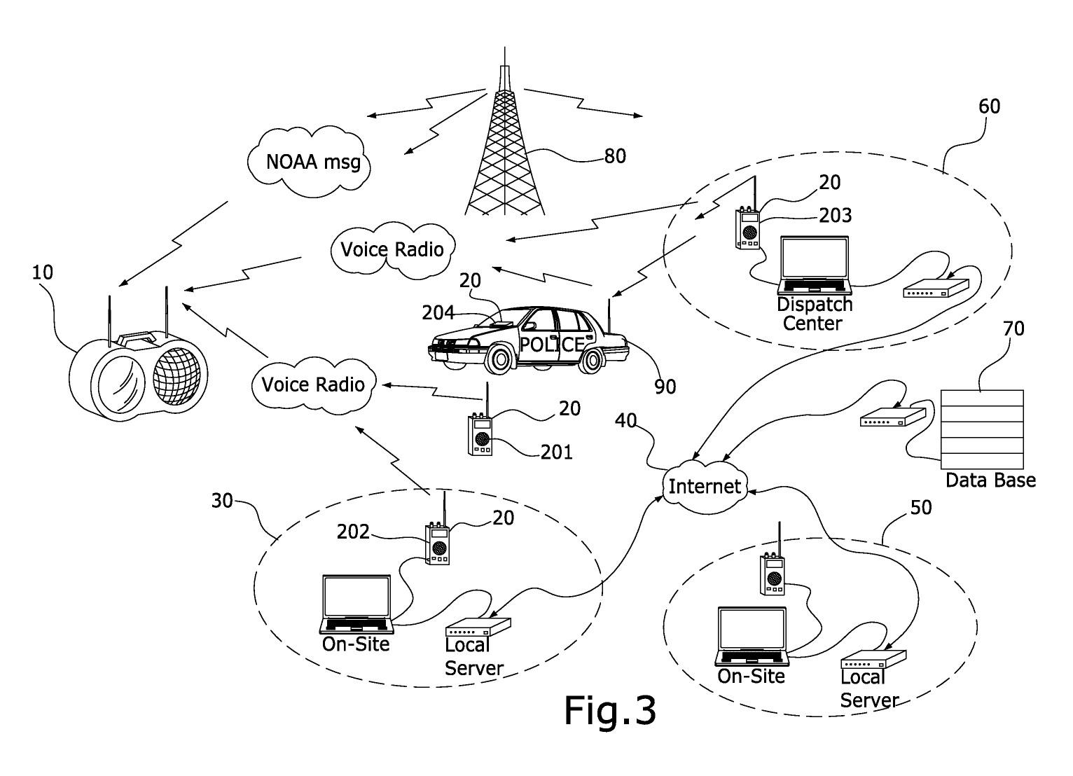

The voice transmitting device 20 can be a regular voice radio transmitter (broadcast station), a two-way radio, or a handset or in-car device of a police system, such as an independent two-way radio 201, or two-way radios 202, 203 connected to an on-site control center 30 and a police dispatch center, or an in-car device 204 installed in a police car 90 shown in FIG. 3. They can transmit data to one or more selected emergency receiving devices 10 through radio channels to establish a system that is capable to announce message at any site. (For example, a rescuer in an emergency event site may use the broadcast system to announce any controlling or alarming message to surrounding traffic or crowds.)

The voice transmitting device 20 may selectively be connected to an on-site control center 30 (such as a communication service center or a security management center) in a wired manner for operation so as to establish a system that receives a message (either regular or emergency) transmitted from the on-site control center 30 and conveys the message through an on-site channel set and selected thereby to various receiving devices 10. The present invention may use an on-site control center to connected through a network 40 to other control centers 50, which may include a police dispatch center 60, a data base 70, or an NOAA based forecast center (not shown in the drawing), for operation, so that the on-site control center 30 may broadcast other distant messages. Further, an on-site control center 30 may install a receiving circuit dedicated to an NOAA channel so that the on-site control center 30 may directly receive and broadcast a message transmitted from an NOAA broadcast station 80, whereby the same effectiveness of receiving on-site commanding, messages from an on-site control center, or emergency public broadcast messages of an expanded area can be realized with simplified circuit architecture of the emergency receiving device 10 and reduction of manufacturing costs thereof.

FIG. 3 demonstrates an example application of the emergency broadcast system. When one of the voice transmitting device 20 of the present invention selects and enters, in a public channel, an address code of a single receiving party or address codes of a plurality of receiving parties, the address code can be a unique address code (a unique and dedicated address code of each emergency receiving device) or an address code of a group (comprising a plurality of emergency receiving devices that are set with the same address code based on administration district, street, or street number of building), or selects a private group channel or other specific on-site channel to set up a range of broadcast. Once the destination or the receiving ends of broadcast is set, the radio transmitter unit of the voice transmitting device 20 carries out transmission of an emergency message.

Taking a group of ten digits as an example, the first two digits indicate administration district, the next two digits indicate street, the fifth to seventh digits indicate building, the eighth and ninth digits indicate building floor, the last digit indicates the device serial number of the same floor. The address code can contain both alphabets and digits and may further include symbols, such as “*” and “?”, as a wildcard code. Further, a simplified look-up table can be provided for easy operation. For example, “0109045***” indicates all the emergency receiving devices in the 45th building of the ninth street of the first administration district may receive the message (this being defined as a common address code, wherein the less number of digits entered indicates the greater range of broadcast). For example, “010904507C” indicates only the C emergency receiving device in the seventh floor of the 45th building of the ninth street of the first administration district may receive the message (this being defined as a dedicated address code).

Coding of the address code is not limited to the above discussed and other way of coding may be available. Further, a simplified code may be designated as an additional address code for the emergency receiving device 10. (For example, “911” may indicate all the emergency receiving devices within the radio reception range may receive the message, or another code is used to indicate that the emergency receiving device of a broadcast station, a group, or a building may receive the message.)

The address selection is performed with numeric/function keys 22 (which can be completely composed of only digital keys or function keys) provided on the voice transmitting device 20. In particular, the function keys can be used to do fast selection of the address codes of certain groups or all of emergency receiving devices to enhance the convenience and practicability of the system.

Then, the emergency receiving device 10 that matches the address code selected by the voice transmitting device 20 receives the signal and the received voice signal is immediately filtered and amplified by the speech amplifier 12 and broadcast by the speaker 13 connected thereto to make announcement to the public. The speaker 13 can be an externally connected high power speaker. Thus, the use of the system of the present invention is not limited to the site where the voice transmitting device 20 is located and the voice transmitting device 20 can serve as a message source within the scope of the transmission range that is supported by the power of the voice transmitting device 20. Thus, maneuverable and immediate broadcast of any emergency message can be realized.

In addition, the emergency receiving device 10 of the present invention can be set in on-line connection with other control centers 50 through a network 40 by the on-site control center 30 to expand the operation scope or range thereof. The emergency receiving device 10 can be set in one or more public channel to serve as a dedicated channel for receiving messages from a police system and/or NOAA, so that an emergency alarm message can be directly received from a patrol car 90 or a dispatch center 60 of a police system or from a NOAA broadcast station and the received message can be broadcast in voice form, even with an interrupting broadcast function with the operation of control circuit 15 (FIG. 1) to get priority of broadcast.

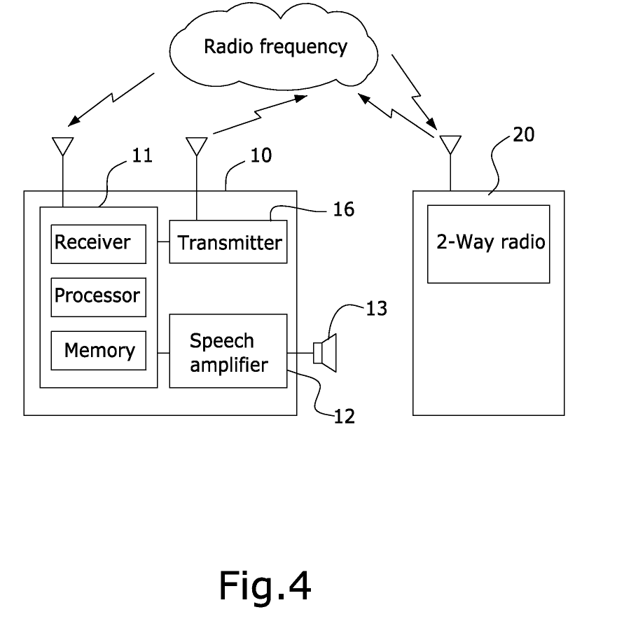

In another embodiment of the present invention (as shown in FIG. 4), the emergency receiving device 10 sets a GPS geographic coordinate code and/or text message of address code built in the radio receiver unit 11 (or the control circuit 15 of FIG. 1), and comprises a transmitter 16 connected to the radio receiver unit 11. The GPS geographic coordinate code is provided by a satellite positioning device (not shown in the drawings) that, when installed, uses a setting program to enter a geographic coordinate code therein into the radio receiver unit 11 (or the control circuit 15) to be stored therein. The transmitter 16 may respond to a calling request transmitted from a voice transmitting device 20 (broadcast source). The calling request code can be a mark of a common emergency message or a common address code or a street number of a building or other specific mark.

As such, when the emergency receiving device 10 receives and confirms the radio signal from the broadcast source comprising a mark or address code corresponding to the calling request, the radio receiver unit 11 uses the transmitter 16 to automatically send back a reception acknowledged message. The acknowledge (Ack) message comprises at least a GPS geographic coordinate code and/or a text message of address code to allow the broadcast sources to use an electronic map display screen to show the GPS geographic coordinate position of all the emergency receiving devices 10 that respond the calling and shows the address codes thereof. Consequently, the system allows an on-site control center 30, other control centers 50, or an emergency event command center or any voice transmitting device 20 to timely acquire the locations and/or detailed address codes of all the emergency receiving devices 10 within a designated range based on the calling request without the knowledge of installation sites of the emergency receiving devices 10, whereby the on-site situation can be clearly known to facilitate control and commanding. Further, the on-site control center 30 of the system may uses the automatic responding mechanism of each emergency receiving device 10 to record the message and location of each emergency receiving device 10 supervised thereby to get further aware of the operation condition of each device to ensure normal operation of the system.

Further, with the above techniques, the system may store the GPS geographic coordinate code of a satellite positioning device in a servo or database of a fixed on-site control center 30 and also stores the GPS geographic coordinates codes and/or other data of the emergency receiving devices 10 supervised thereby to the servo or database of the on-site control center so that any broadcast source or maneuverable emergency event command center may access the on-site control center 30 to acquire the GPS geographic coordinate data and/or other data of each emergency receiving device 10.

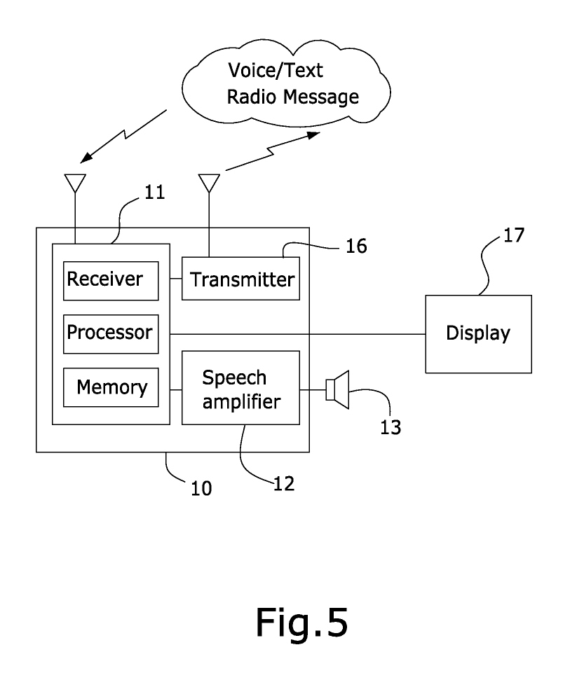

In a further embodiment of the present invention (as shown in FIG. 5), the emergency receiving device 10 further comprises a display 17 connected to the radio receiver unit 11 (or the control circuit 15 of FIG. 1). The display 17 can be a liquid crystal display mounted on a casing of the emergency receiving device 10 or a large-sized electronic displaying panel that is external to the emergency receiving device 10.

As such, the emergency receiving device 10 may use the radio receiver unit 11 to receive text message of an emergency event transmitted from a broadcast source or a control center based on the dedicated or common address code and process and display the text message of the emergency broadcast on the display 17 so as to provide the public with a way to visually receive the emergency broadcast message transmitted from a remote site.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A system of the broadcast for transmitting emergency message using a radio device, the system comprising a plurality of emergency receiving devices distributed in a building or a given area and at least one voice transmitting device, wherein
the emergency receiving device comprises at least one radio receiver unit and a speech amplifier, the radio receiver unit setting up at least an address code and a radio channel, in which a voice message is transmitted from the voice transmitting device and received by the radio receiver unit and is then subjected to signal amplification by the speech amplifier to be broadcast by a speaker connected to the speech amplifier in a voice form to be heard by the public; and
the voice transmitting device comprises at least one radio transmitter unit, in which an RF transmitter of the radio transmitter unit transmits a voice signal of the voice message to the emergency receiving device.

2. The system according to claim 1, wherein the address code of the radio receiver unit comprises at least a common address code.

3. The system according to claim 1, wherein the address code of the radio receiver unit comprises a dedicated address code and at least a common address code.

4. The system according to claim 1, wherein the address code of the radio receiver unit comprises coding indicating at least one of a district, a street, a building floor, and a serial code of receiving device in the same floor.

5. The system according to claim 1, wherein the receiving channel of the radio receiver unit comprises one or more public channels.

6. The system according to claim 5, wherein the receiving channel further comprises an on-site channel.

7. The system according to claim 5, wherein the public channel comprises a channel of police system or NOAA emergency broadcast system.

8. The system according to claim 1, wherein the emergency receiving device further comprises with an emergency lighting unit connected with radio receiver unit by a control circuit;
the emergency lighting unit comprising a lighting circuit that is composed of a charging circuit, a storage battery, a power supply circuit, and a light; and
the control circuit detecting if an AC power source is cut off and/or deciding if a message received by the radio receiver unit is an emergency message, whereby when the AC power source is cut off and/or the radio receiver unit receives an emergency message, the control circuit generates a control signal to automatically activate emergency lighting and supply electrical power for lighting and broadcasting.

9. The system according to claim 8, wherein the radio receiver unit and the speech amplifier of the emergency receiving device are connected to the control circuit so as to perform interrupting broadcast when the control circuit determines that a signal received by the radio receiver unit is an emergency message.

10. The system according to claim 1, wherein the voice transmitting device comprises any one of a regular voice transmitter, a two-way radio, or a handset or in-car device of a police system.

11. The system according to claim 10, wherein the voice transmitter or the two-way radio is connected to an on-site control center in a wired manner.

12. The system according to claim 11, wherein the on-site control center is connected through a network to other control centers for operation.

13. The system according to claim 11, wherein the on-site control center sets up a receiving circuit dedicated to receiving an NOAA channel.

14. The system according to claim 1, wherein the emergency receiving device further comprises setting a message of GPS geographic coordinate code in the radio receiver unit and comprises a transmitter connected to the radio receiver unit for responding to a calling request from a voice transmitting device.

15. The system according to claim 14, wherein an Ack message returned by the transmitter comprises the message of at least a GPS geographic coordinate code.

16. The system according to claim 1, wherein the emergency receiving device further comprises a display connected to the radio receiver unit to display an emergency message that is transmitted as a text message.
